(19) United States
(12) Patent Application Publication
(10) Pub. No.: US 2010/0274649 A1
(43) Pub. Date: Oct. 28, 2010

(54) CREDIT CARD PROVIDING ENHANCED BENEFITS, METHOD AND SYSTEM FOR USING SAME

(76) Inventor: MARK A. SMITH, Downers Grove, IL (US)

Correspondence Address: MICHAEL P. MAZZA, LLC, 686 CRESCENT BLVD., GLEN ELYN, IL, 60137, US

(21) Appl. No.: 12/428,343

(22) Filed: Apr. 22, 2009

(51) Int. Cl. G06Q 30/00; G06Q 90/00; G06Q 40/00

(52) U.S. Cl. 705/14.15; 705/500; 705/39

(57) ABSTRACT

A credit card that enables card-holders to pay for premiums on the insurance product using the credit card, while avoiding the need to pay deductibles on the insurance product (which may be used to cover auto, home, liability or health). Entities such as those underwriting the insurance product, self-insuring credit card issuers, or third-party financial institutions, may pay the deductibles. A method for using the credit card also forms a part of the invention. A website may be provided to enable card-holders to select among various insurance products, and to facilitate credit card payments by the card-holders. Computers may be used by the various involved parties to compute break-even profit points, deductibles, lowered credit card interchange fees, etc.

### BACKGROUND OF THE INVENTION

The present invention relates to a method and system for using credit cards to pay insurance premiums. More specifically, such a method and system is employed in which an entity other than the credit card-holder pays the deductibles on the corresponding insurance policies.

In recent years so-called “reward” programs have proliferated in which credit cards have been used to provide card-holders with various ancillary benefits, including rebates in the form of airline miles, cash back for purchases, or cash down payments for various items. Such programs have proven useful in attracting credit card customers, as well as in expanding the businesses of the credit card companies and aligned vendors. Within the insurance market niche, usage of some credit cards to pay for passenger fares or auto rentals, for example, also provides such card-holders with embedded insurance benefits (e.g., purchase assurance coverage, auto rental collision damage waiver programs, common carrier travel accident insurance coverage, etc.).

Inventors have proposed an alliance between credit card companies and insurance companies so that rebates generated from credit card purchases may be used to provide insurance benefits (see, e.g., U.S. Pat. No. 7,246,068 to Thomas, and U.S. Pat. No. 6,386,644 and U.S. Pat. No. 6,745,938, each to Sullivan). Credit card payments for various auto (e.g., auto loan lease) or home (e.g., home loan lease) purchases have also been eligible for various insurance-related rewards, but no method or system to the present inventor's knowledge has ever coupled the actual payment of the insurance policy premium with the “reward” of deductible reimbursement.

There are insurance companies (e.g., Allstate) which offer the convenience of paying auto or homeowner premiums with a credit card. However, to date, cross-pollination between the insurance and credit card industries has been fairly limited. As one example, the inventor has worked in both markets and finds that it would be rare for any insurance marketing executive to understand the intricacies of credit card transactions (exemplary transactions shown in FIG. 1) and its associated costs and revenues. Similarly, it would be rare for a credit card marketing executive to understand the details of auto or homeowner insurance policies (see examples in FIGS. 2A and 2B).

Most forms of risk/insurance protection (auto, home, liability, casualty, health, etc.) require some degree of “self-insurance” (e.g., deductibles and waiting periods) before the policy benefits are paid. It would be advantageous to use the structured revenue of a credit card transaction to pay the cost of such “self-insurance,” enabling card-holders that pay their insurance premiums using a credit card to avoid having to pay their deductibles and/or avoid waiting periods. It would also be advantageous to realize such advantages across a broad spectrum of insurance offerings, including those related to auto, home, liability, casualty, health, etc.

### DEFINITION OF CLAIM TERMS

The terms used in the claims of the patent as filed are intended to have their broadest meaning consistent with the requirements of law. Where alternative meanings are possible, the broadest meaning is intended. All words used in the claims are intended to be used in the normal, customary usage of grammar and the English language.

“Credit card” is used more broadly here than in the conventional sense, and means not only traditional credit cards, but also debit cards, for example. The credit cards used within the invention could be for satisfying general debts, or they could be dedicated, single-focus credit cards intended to satisfy only certain types of debts, e.g., gas-only, insurance-only, etc.

“Insurance product” means any product that may be purchased by a consumer and underwritten against a risk, including but not limited to auto, home, liability (i.e., property or casualty), or health.

### SUMMARY OF THE INVENTION

The objects mentioned above, as well as other objects, are solved by the present invention, which overcomes disadvantages of prior systems and methods for linking credit card and insurance payment systems, while providing new advantages not previously associated with such systems and methods.

In one preferred embodiment of the invention, a credit card is provided pursuant to a contract between the card issuer and a card-holder, enabling the card-holder to pay for an insurance product used by the card-holder. The contract allows the card-holder to pay for premiums on the insurance product using the credit card, and the contract also allows the card issuer to waive any requirement that the card-holder pay any deductible that might otherwise be required to be paid on the insurance product. In an alternative embodiment, the card-holders using the credit card pursuant to the contract represent a subset of all card-holders of the issuer. (The subset may be selected by the card issuer based on credit ratings and/or annual income, etc.) In one preferred embodiment, an entity other than the card-holder pays the deductibles on the one or more insurance products. Such a deductible-paying entity may be one or more of the following selected from the group: a self-insuring credit card issuer; an insurance company offering the insurance product; or a third-party financial institution.

In an alternative embodiment of the invention, a method is provided for obtaining insurance using a credit card. In one step, a credit card-holder pays for the purchase of an insurance product by using the credit card. Earlier, the card issuer agreed that as an inducement for such transaction, the deductible on the insurance product need not be paid by the card-holder. Next, an entity other than the card-holder (such as the underwriter of the insurance product, a self-insuring credit card issuer, or a third-party financial institution) pays the deductible on the insurance product. In one preferred embodiment, the credit card issuer pays the insurance premiums for the insurance product to an insurance carrier for underwriting the risk of the insurance product.

The insurance product paid for by the credit card of the invention may be selected from one or more of the following in the group: auto, home, liability or health insurance.

In another embodiment of the invention, a method is provided for obtaining insurance using a credit card. In one step, a credit card-holder or its agent may use one or more computers to perform an analysis to confirm the profitability of supplying the credit cards for use by card-holders. Next, an insurance product may be purchased using the credit card. The issuer of the credit card has earlier agreed that as an inducement for such transaction, the deductible on the insurance product need not be paid by the card-holder. Now, an entity other than the card-holder may be permitted to pay the deductible on the insurance product. One or more of the same or different computers may be used to determine one or more classes or groups of card-holders eligible for the credit card (such as classes or groups selected based upon credit ratings and/or annual incomes of the card-holders).

In another embodiment of the present invention, a method is provided for obtaining insurance using a credit card in which a credit card issuer reaches agreement with an underwriter of insurance or its agent concerning terms and conditions for the use of the credit card to purchase one or more insurance products. A credit card-holder or its agent may use one or more computers to compute deductible amounts to be waived for the one or more insurance products. The card-holders may purchase the one or more insurance products using the credit card. The issuer of the credit card has earlier agreed that the deductible on the insurance product need not be paid by the card-holder. Again, an entity other than the card-holder may or may be required to pay the deductible on the insurance product. One or more computers may be used to compute new, decreased interchange fees associated with the credit cards.

In still another embodiment of the invention, a method is provided for obtaining insurance using a credit card in which a website is provided, enabling card-holders of the credit card to pay for the purchase of one or more insurance products on-line by using the credit card. The issuer of the credit card has earlier agreed that as an inducement for such transactions, the deductibles on the one or more insurance products need not be paid by the card-holders. Again, an entity other than the card-holder may or may be required to pay the deductibles on the one or more insurance products. It may be preferred that card-holders be permitted to use the website to select among different insurance products. The website may be permitted to display attributes of the one or more insurance products, and card-holders may be permitted to use the website to: (a) identify account information associated with the one or more insurance products selected by the card-holders; (b) input transactional information relating to the credit card of the card-holders; and (c) link the account information with the transactional information. The website may also be used to electronically transmit information relating to the selected one or more insurance products to a remote processing system (such as PenPal, etc.).

Card issuers may also choose to use an electronic storage medium which they or a third-party agent manages to store information relating to card-holder transactions concerning the credit cards.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings. The drawings illustrate currently preferred embodiments of the present invention. As further explained below, it will be understood that other embodiments, not shown in the drawings, also fall within the spirit and scope of the invention.

FIG. 1 is a schematic diagram showing exemplary credit card transactions;

FIGS. 2A and 2B are schematic diagrams showing exemplary auto and homeowner policy summaries (i.e., sample declaration pages), respectively;

FIGS. 3A and 3B are schematic diagrams showing the basic flow of a typical transaction using a credit card according to the present invention (FIG. 3A), and illustrating how the consumer benefits from such a transaction (FIG. 3B); and

FIG. 4 is a schematic diagram illustrating how the credit card company benefits from the transactions indicated in FIG. 3.

The components in the drawings are not necessarily exact, as emphasis is instead placed upon clearly illustrating the general principles of the present invention.

### DETAILED DESCRIPTION OF THE PREFERRED EMBODIMENTS

Set forth below is a description of what are currently believed to be the preferred embodiments and/or best examples of the invention claimed. Future and present alternatives and modifications to these preferred embodiments are contemplated. Any alternatives or modifications which make insubstantial changes in function, in purpose, in structure or in result are intended to be covered by the claims of this patent.

The present invention has its genesis in the surprising recognition that it would be desirable to restructure credit card contracts (terms and conditions) and insurance policies to include these obligations: (1) the card-holder agrees to pay insurance premiums on a particular policy using his/her credit card; and (2) a suitable third party (the card issuer if it self-insures, the insurance company, or a related third party) agrees to pay the insured's corresponding deductibles. An explanation of why the parties involved would find this desirable, and the reason why this restructuring would be economically advantageous to all parties involved, now follows.

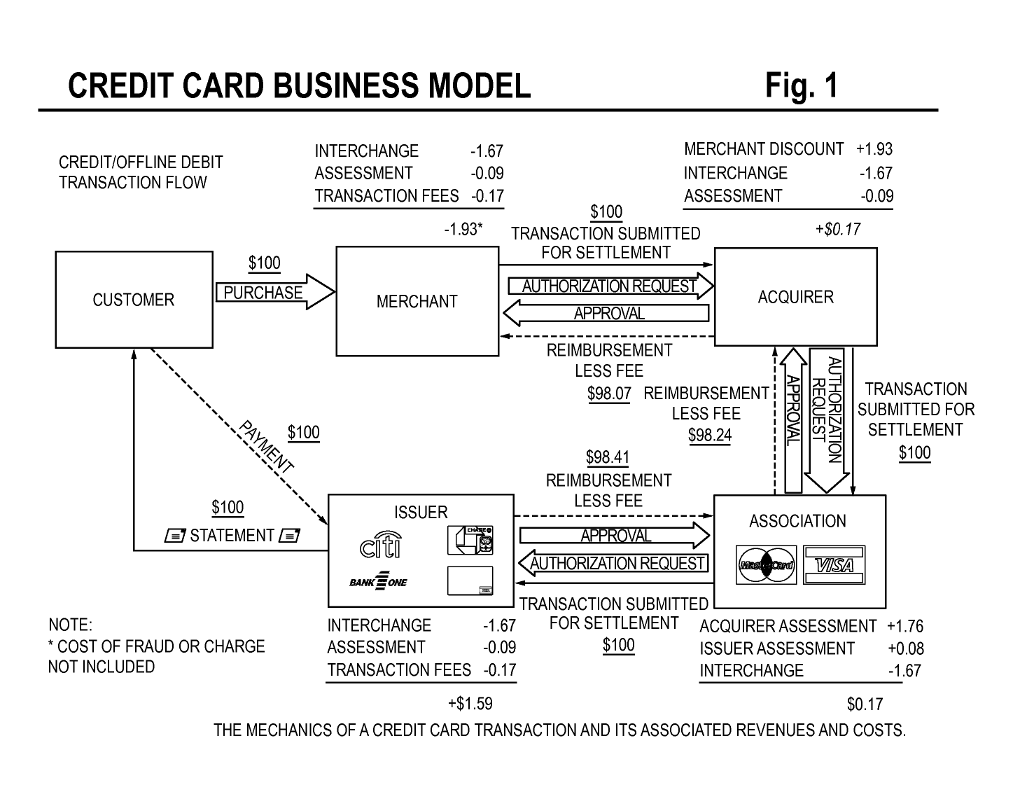

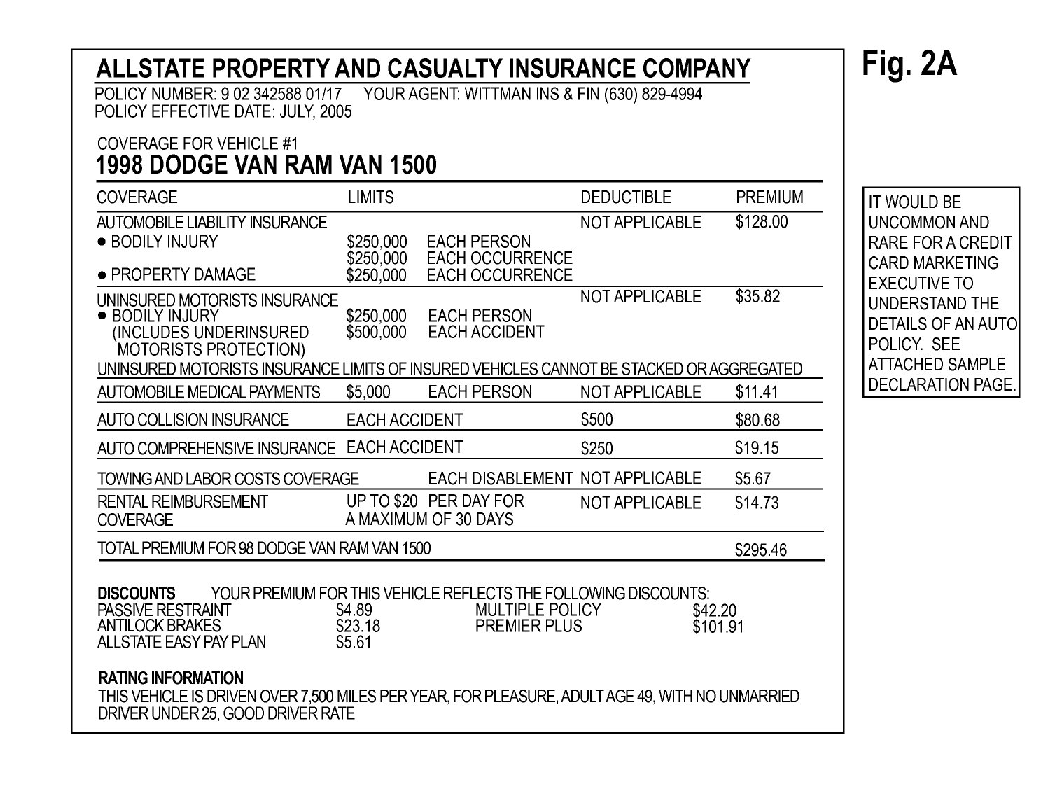

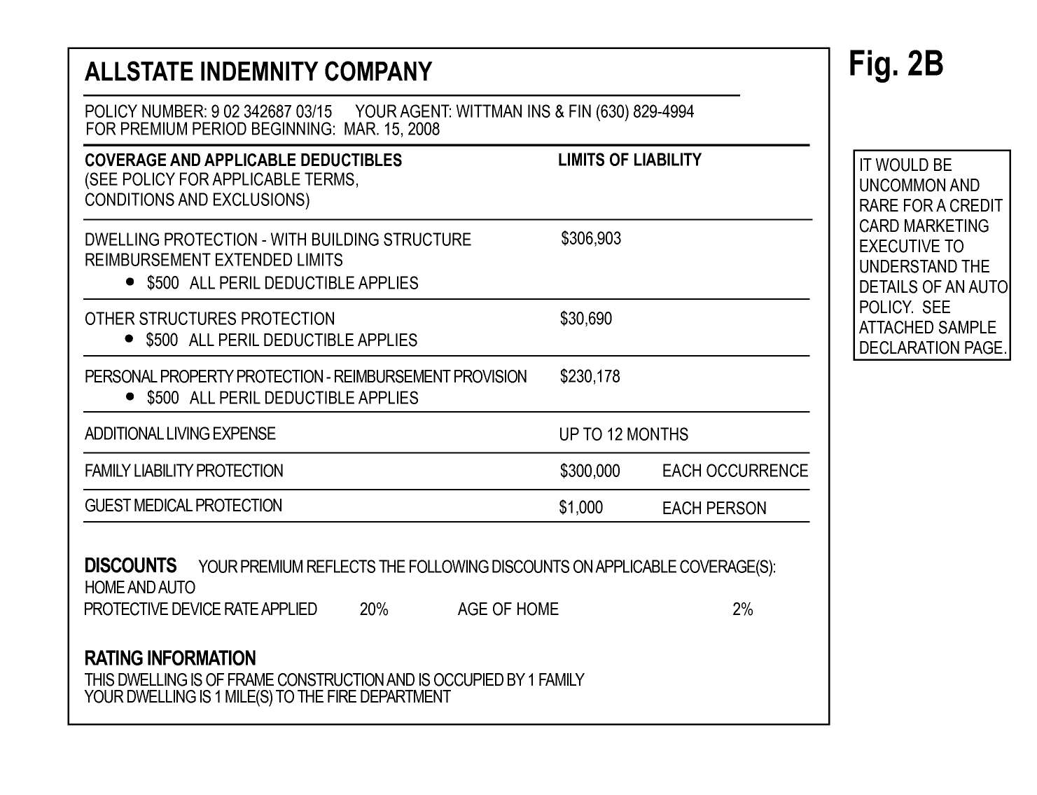

Referring first to FIG. 1, as background, a typical credit card business transaction model is shown. In this model, a customer/credit card-holder purchases a consumable good or service for $100. A typical credit card transaction involves five parties (Customer, Merchant, Acquirer, Association, and Issuer). When the Acquirer and the Issuer are the same entity, which is not uncommon, the number of parties is reduced to four. When John or Jane Doe purchases a good or service, the Merchant accepts the credit card and moves it through the electronic plumbing for settlement and reimbursement. In general, the process involves sending (Merchant) the card transaction through the system for authorization and settlement (Issuer). Once the transaction is settled/approved by the Issuer, the transaction/approval returns through the system, minus the associated costs, to its point of origin (Merchant).

To take a specific example, on a $100 purchase, the Issuer earns the full purchase price ($100.00) and the Merchant receives $98.07. The difference, $1.93, is deducted by all the parties involved in the transaction. The Issuer's net charge equals $1.59; the Association's net charge equals $0.17; and the Acquirer's net charge equals $0.17, which total $1.93. The specific deductions are as follows:

Issuer receives full purchase price: $100.00

Issuer's fee: $1.59 (interchange fee)

Credit card company reimbursement less fees: $98.41

Association's net fee: $0.17

Association's reimbursement less fees: $98.24

Acquirer's net fee: $0.17

Acquirer's reimbursement less fees: $98.07

Merchant reimbursement: $98.07

A detailed understanding of the typical credit card transaction system, as shown in FIG. 1 and explained above, enabled the inventor to appreciate that: (1) the interchange fee charged by the card issuer (typically a bank) to a merchant is more than sufficient to cover the cost of “self-insurance” incurred by consumers who purchase auto, home, liability or health insurance that contain deductibles; and (2) the financial enterprises that underwrite the associated risk (insurance companies) will appreciate both the benefits of (1) and the corresponding benefits of an enlarged base of policyholders, which results in increased revenue for the insurance company.

Using the present invention, after the cardholder pays insurance premiums using his/her credit card, and an insurable incident occurs, the cardholder need not pay the deductible; another entity pays the deductible on behalf of the cardholder/insured (e.g., the insurance company).

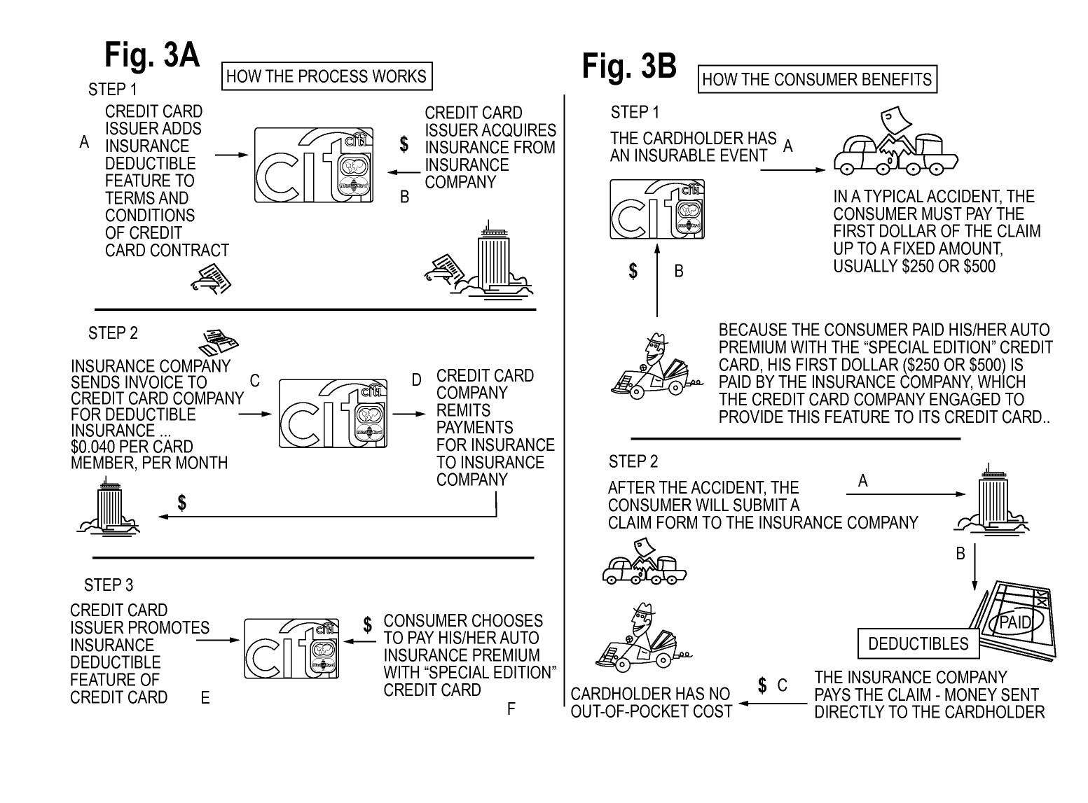

In one preferred embodiment, referring now to FIG. 3A, in order for the credit card company to offer a card according to the present invention, it must change the terms and conditions of its contract (FIG. 3A, Step 1A). Once the contract has been modified, the credit card company must then engage the services of an insurance company (FIG. 3A, Step 1B). The insurance company sends an invoice to the credit card company (at a rate of perhaps 3-4 cents/cardholder/month) for the covered risk (see FIG. 3A, Step 2C). The credit card company may then remit payment for the insurance coverage to the insurance company (FIG. 3A, Step 3D). When the terms of the covered risk are outlined, the cardholder can pay his/her insurance premium using the “special edition” credit card of the invention (FIG. 3A, Step 3F). As mentioned above, at the time of an insurable incident (e.g., an accident) (FIG. 3B, Step 1A), the cardholder may submit a claim to the insurance company to cover the cost of the required deductible (FIG. 3B, Step 2A). The insurance company may then provide the insurance protection it contracted to provide to the card issuer (e.g., pay a $500 deductible) (FIG. 3B, Step 2C), resulting in no out-of-pocket cost to the card-holder.

It will be appreciated that the card issuer/credit card company will be willing to restructure its contracts (terms and conditions) because of the increased number of credit card transactions it will expect to realize due to customers attracted to the new card features (because, e.g., the card-holder need not pay its insurance deductibles). On this increased number of transactions, the card issuer will continue to receive an interchange fee each time the credit card is used. This interchange fee may only be slightly less than the fee associated with a conventional credit card transaction that does not have these features (perhaps 1.50%-−1.55% versus 1.60%, based on the above cost/month of insurance protection of about 4 cents/cardholder/month). Use of the present invention will also benefit the insurance company, which can expect not only to build a new block of business, but to do so from a potentially very creditworthy source (assuming the card issuer had earlier performed due diligence on its prospective customer base).

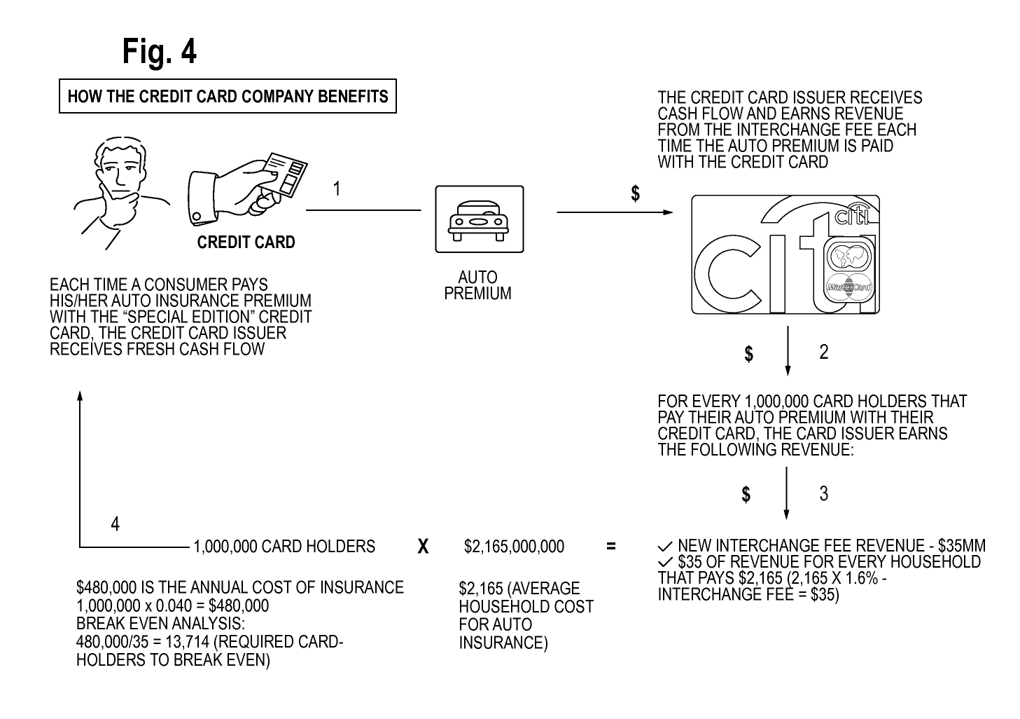

Referring now to FIG. 4, a “breakeven” analysis will show how economically desirable the invention can be to credit card issuers. Assume $2,165 is the average household cost for auto insurance (derived from Insurance Information Institute estimates). Multiplying this by the 1.6% interchange fee (the cost of doing business on the “credit card highway”) yields $35/household in revenue to the credit card issuer. An insurance industry source indicates that about $480,000 is the annual cost of offering the insurance incurred by the credit card issuer, assuming a card base of one million card-holders. Given this assumption, then the issuer must involve 13,714 card-holders who employ the card to pay their auto insurance premiums in order to break even (13,714*$35=$480,000).

Assuming instead that $1,000 is the average individual cost for auto insurance, similar calculations show that 30,000 card-holders are required to break even ($1000*1.6%*30,000=$4480,000).

The US Census Bureau indicates, based on 2005 data, that there were 164 million card-holders in the U.S., holding about 1.4 billion cards (an average of 9 credit cards issued per credit card-holder). For every 1 million cardholders that direct their auto premium to a credit card of the present invention, this translates (given the $2,165 average household auto premium) into $2.165 billion in premiums paid, and about $35 million in new revenue to the credit card issuer ((1M cardholders)*($2165 average premium)*(1.6% credit card interchange fee)), against the fixed insurance expense of $480K. If all or a substantial percentage of the 164 million card-holders used the cards to pay auto premiums, this would yield billions in new revenue to the card issuers.

U.S. customers currently pay insurance companies premiums in the amount of: $216B for auto/property; $85B for life; $336 for annuities; $23B for supplemental health; and $183B for all other health. A significant portion of this $843 billion in insurance premiums could be paid by credit cards, driving insurance premiums to card issuers, and motivating them to partner with key insurance carriers that would be willing to develop billing for issuer card-holders.

The use of a credit card according to the present invention is a significant departure from the dominant “push” marketing method currently employed by credit card companies: i.e., “Pay your car insurance bill automatically with any American Express Card”; “Geico Platinum MasterCard . . . simply sign up for our Recurring Premium Payment plan with your Geico Platinum MasterCard and we'll waive all installment fees. Plus you pay no annual fee for all of your Platinum benefits and all these savings.” In contrast, with the present invention, a “pull” methodology is used in which consumers are openly and directly rewarded for using their credit card to solve or address a bonafide financial need.

Continuing with the “pull” paradigm, use of this new card would encourage integration between insurance companies and issuers. Financial protection products can be used to entice customers, leading to increased interchange fees, higher balances, co-brand and private label opportunities, and increased issuer retention rates. The issuer could come to own or dominate the premium payment aspect of insurance, with insurance sales becoming secondary.

As a further example, using the credit card of the present invention, a consumer could increase his/her auto insurance deductible from $250 to $500. By paying their auto premium with a credit card of the present invention, the card-holder can choose a higher deductible (e.g., $500 to $1000), which lowers his/her cost of insurance (out-of-pocket costs). This also provides the convenience of credit card billing, while enabling the card-holder to obtain benefits (e.g., deductible paid) for paying a bill that would have to be paid regardless of where the insurance was purchased.

In another embodiment of the invention, the card-holders using the “special edition” credit card of the present invention pursuant to the contract represent a subset of all card-holders of the issuer. This subset may be preferred by the card issuer because they constitute a lower-risk group, for example (e.g., those selected on the basis of preferred credit ratings, higher annual incomes, etc.).

It will be understood that various modifications to the preferred embodiment disclosed above may be made. The above description is not intended to limit the meaning of the words used in the following claims that define the invention. Rather, it is contemplated that future modifications in structure, function or result will exist that are not substantial changes and that all such insubstantial changes are intended to be covered by the following claims.

I claim:

1. A credit card used pursuant to a contract between the card issuer and a card-holder to pay for an insurance product covering the card-holder, wherein the contract permits the card-holder to pay for premiums on the insurance product using the credit card, and wherein the contract permits the card issuer to waive any requirement that the card-holder pay any deductible that might otherwise be required on the insurance product.

2. The credit card of claim 1, wherein the card-holders using the card pursuant to the contract represent a subset of all card-holders of the issuer.

3. The credit card of claim 1, wherein an entity other than the card-holder pays the deductible.

4. The credit card of claim 3, wherein the entity is one or more of the following selected from the group: a self-insuring credit card issuer; an insurance company offering the insurance product; or a third party financial institution.

5. A method for obtaining insurance using a credit card, comprising the steps of:
a credit card-holder purchasing one or more insurance products by using the credit card, wherein the issuer of the credit card has earlier agreed that as an inducement for such transaction, the deductible on the one or more insurance products need not be paid by the card-holder; and
an entity other than the card-holder paying the deductible on the one or more insurance products.

6. The method of claim 5, wherein the underwriter of the insurance product pays the deductible.

7. The method of claim 5, wherein the credit card issuer comprises a self -insurer which pays the deductible.

8. The method of claim 5, wherein the credit card issuer pays an insurance premium to an insurance carrier for underwriting the risk of the insurance product.

9. The method of claim 5, wherein the insurance product comprises one or more of the following selected from the group: auto, home, liability or health insurance.

10. A method for obtaining insurance using a credit card, comprising the steps of:
a credit card-holder or its agent using one or more computers to perform an analysis to confirm the profitability of supplying the credit cards for use by card-holders;
purchasing an insurance product by using the credit card, wherein the issuer of the credit card has earlier agreed that as an inducement for such transaction, the deductible on the insurance product need not be paid by the card-holder; and
an entity other than the card-holder paying the deductible on the insurance product.

11. The method of claim 10, further comprising the step of using one or more of the same or different computers to determine one or more classes or groups of card-holders eligible for the credit card.

12. The method of claim 11, wherein the classes or groups are selected based upon credit ratings and/or annual incomes of the card-holders.

13. A method for obtaining insurance using a credit card, comprising the steps of:
a credit card issuer reaching agreement with an underwriter of insurance or its agent concerning terms and conditions for the use of the credit card to purchase one or more insurance products;
a credit card-holder or its agent using one or more computers to compute deductible amounts to be waived for the one or more insurance products; and
the card-holders purchasing the one or more insurance products using the credit card, wherein the issuer of the credit card has earlier agreed that the deductible on the insurance product need not be paid by the card-holder.

14. The method of claim 13, further comprising the step of an entity other than the card-holder paying the deductible on the insurance product.

15. The method of claim 13, further comprising the step of using one or more computers to compute new, decreased interchange fees associated with the credit cards.

16. A method for obtaining insurance using a credit card, comprising the steps of:
providing a website enabling card-holders of the credit card to pay for the purchase of one or more insurance products by using the credit card, wherein the issuer of the credit card has earlier agreed that as an inducement for such transactions, the deductibles on the one or more insurance products need not be paid by the card-holders.

17. The method of claim 16, further comprising the step of an entity other than the card-holder paying the deductibles on the one or more insurance products.

18. The method of claim 16, wherein card-holders can use the website to select among different insurance products.

19. The method of claim 16, further comprising the step of using of an electronic storage medium enabling the credit card issuer to store information relating to card-holder transactions concerning the credit cards.

20. The method of claim 16, wherein the website displays attributes of the one or more insurance products, and further comprising the step of the card-holders using the website to: (a) identify account information associated with the one or more insurance products selected by the card-holders; (b) input transactional information relating to the credit card of the card-holders; and (c) link the account information with the transactional information.

21. The method of claim 20, further comprising the step of using the website to electronically transmit information relating to the selected one or more insurance products to a remote processing system.
